(19) United States
(12) Patent Application Publication
(10) Pub. No.: US 2010/0278232 A1
(43) Pub. Date: Nov. 4, 2010

(54) Method Coding Multi-Layered Depth Images

(76) Inventors: Sehoon Yea, Cambridge, MA (US); Anthony Vetro, Arlington, MA (US)

Correspondence Address: MITSUBISHI ELECTRIC RESEARCH LABORATORIES, INC., 201 BROADWAY, 8TH FLOOR, CAMBRIDGE, MA, 02139, US

(21) Appl. No.: 12/435,057

(22) Filed: May 4, 2009

(51) Int. Cl. H04N 7/26; G06K 9/36

(52) U.S. Cl. 375/240.08; 375/E07.126; 382/233; 382/238; 375/E07.243

(57) ABSTRACT

A method reconstructs a depth image encoded as a base layer bitstream, and a set of enhancement layer bitstreams. The base layer bitstream is decoded to produce pixels of a reconstructed base layer image corresponding to the depth image. Each enhancement layer bitstream is decoded in a low to high order to produces a reconstructed residual image. During the decoding of the enhancement layer bitstream, a context model is maintained using an edge map, and each enhancement layer bitstream is entropy decoded using the context model to determine a significance value corresponding to pixels of the reconstructed residual image and a sign bit for each significant pixel, and a pixel value of the reconstructed residual image is reconstructed according to the significance value, sign bit and an uncertainty interval. Then, the reconstructed residual images are added to the reconstructed base layer image to produce the reconstructed depth image.

### RELATED APPLICATION

This Application is related to U.S. application Ser. No. 12/405,864, “Depth Reconstruction Filter for Depth Coding Videos,” filed by Yea et al., on Mar. 17, 2009.

### FIELD OF THE INVENTION

This invention relates generally to efficient representations of depth videos, and more particularly, to coding depth videos accurately for the purpose of synthesizing virtual images for novel views.

### BACKGROUND OF THE INVENTION

Three-dimensional (3D) video applications, such as 3D-TV and free-viewpoint TV (FTV) require depth information to generate virtual images. Virtual images can be used for free-view point navigation of a scene, or various other display processing purposes.

One problem in synthesizing virtual images is errors in the depth information. This is a particular problem around edges, and can cause annoying artifacts in the synthesized images, see Merkle et al., “The Effect of Depth Compression on Multiview Rendering Quality,” 3DTV Conference: The True Vision—Capture, Transmission and Display of 3D Video, Volume, Issue, 28-30 May 2008 Page(s):245-248.

### SUMMARY OF THE INVENTION

The embodiments of this invention provide a multi-layered coding scheme for depth images and videos. The method guarantees that the maximum error for each reconstructed pixel is not greater than an error limit. The maximum error can vary with each coding layer to enable a successive refinement of pixel values in the image. Within each coding layer, the error limit can also be adapted to account for local image characteristics such as edges that correspond to depth discontinuities.

### BRIEF DESCRIPTION OF THE DRAWINGS

FIGS. 1A and 1B are block diagrams of a multi-layered encoder and multi-layered decoder according to embodiments of the invention;

FIGS. 2A, 3A and 4A are block diagrams of an enhancement layer bitstream encoder according to embodiments of the invention;

FIGS. 2B, 3B and 4B are block diagrams of an enhancement layer bitstream decoder according to embodiments of the invention; and

FIGS. 5A and 5B are respectively graphs of non-adaptive and adaptive setting of an error limit according to embodiments of the invention.

### DETAILED DESCRIPTION OF THE PREFERRED EMBODIMENTS

Virtual View Synthesis

Our virtual image synthesis uses camera parameters, and depth information in a scene to determine texture values for pixels in images synthesized from pixels in images from adjacent views (adjacent images).

Typically, two adjacent images are used to synthesize a virtual image for an arbitrary viewpoint between the adjacent images.

Every pixel in the two adjacent images is projected to a corresponding pixel in a plane of the virtual image. We use a pinhole camera model to project the pixel at location (x, y) in the adjacent image c into world coordinates [u, v, w] using

[u, v, w]^{T}=R_{c}·A_{c}⁻¹·[x, y, 1]^{T}·d[c, x, y]+T_{c}, (1)

where d is the depth with respect to an optical center of the camera at the image c, and A, R and T are the camera parameters, and the superscripted T is a transpose operator.

We map the world coordinates to target coordinates [x′, y′, z′] of the virtual image, according to:

Xᵥ=[x′, y′, z′]^{T}=Aᵥ·Rᵥ⁻¹·[u, v, w]^{T}−Tᵥ. (2)

After normalizing by z′, a pixel in the virtual image is obtained as [x′/z′, y′/z′] corresponding to the pixel [x, y] in the adjacent image.

For texture mapping, we copy the depth and the corresponding texture I[x, y] from the current adjacent image (c) into the corresponding location [x′/z, y′/z′] in virtual image depth and texture buffers. Depth and texture buffers are maintained for each adjacent image to generate the synthesized image.

Due to quantization of the projected location in the virtual buffers, the values for some pixels in the virtual image buffers are missing or undefined. To render the virtual image, we scan through each location in the two virtual image depth buffers and apply the following procedure.

If both depths are zero, then there is no texture information. This causes a hole in the synthesized image.

If one depth is non-zero, then use the texture value corresponding to the non-zero depth.

If both depths are non-zero, then we take a weighted sum of the corresponding texture values. To improve the quality of the final rendered image, filtering and in-painting can be applied. We prefer a 3×3 median filter to recover undefined areas in the synthesized image.

A direct transformation from a current camera to a virtual camera can be obtained by combining Equations (1) and (2):

Xᵥ=[x′, y′, z′]^{T}=M₁·d·X_{c}+M₂, (3)

where M₁=Aᵥ·Rᵥ⁻¹·R_{c}·A_{c}⁻¹, and M₂=Aᵥ·Rᵥ⁻¹·{T_{c}−Tᵥ}.

Analysis of Depth Error for Virtual View Synthesis

If there is a depth-coding error Δd, then the corresponding error in the location in the virtual camera ΔXᵥ is

ΔXᵥ=M₁·X_{c}·Δd. (4)

Both Xᵥ and Xᵥ+ΔXᵥ are normalized to determine corresponding coordinates of the virtual camera. After the normalization, the texture-mapping error is

$${E}_{map} = [ \frac{{x}^{′}}{{z}^{′}} , \frac{{y}^{′}}{{z}^{′}} ] - [ \frac{{x}^{′} + Δ {C}_{v} ( 1 )}{{z}^{′} + Δ {X}_{v} ( 3 )} , \frac{{y}^{′} + Δ {X}_{v} ( 2 )}{{z}^{′} + Δ {X}_{v} ( 3 )} ] . \qquad ( 5 )$$

Using conventional coding schemes, larger depth coding errors can occur along object boundaries. The texture-mapping errors are also larger around the same boundaries.

Equation (5) indicates that the texture-mapping error depends on the depth coding error and other parameters, such as camera configurations and the coordinate of the point to be mapped.

If the camera parameters and depth information are sufficiently accurate, then a strict control on the depth is beneficial because the depth represents the geometrical distance in the scene. This is especially true near depth edges, which typically determine the boundary of an object.

In a multi-view video, a depth image is estimated for each view. A pixel in the depth image represents a distance to a 3D point in the scene. The distance must be accurate because a quality of virtual image synthesis is highly dependent on the depth. Therefore, it is crucial to balance the quality of the depth image and an associated bandwidth requirement.

Computer System and Method Overview

Therefore, the embodiments of the invention provide a multi-layered coding scheme for depth images and videos. The method guarantees that the maximum error for each reconstructed pixel is limited. The maximum error varies with each coding layer allowing a successive refinement of pixel values in the image. Within each coding layer, the error limit can also be adapted to account for local image characteristics such as edges that correspond to depth discontinuities.

System Overview

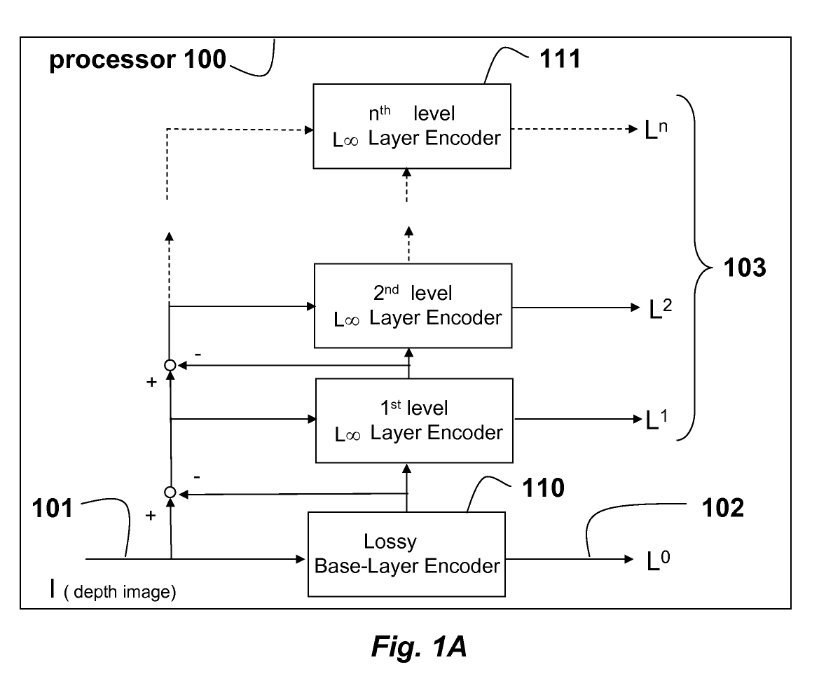

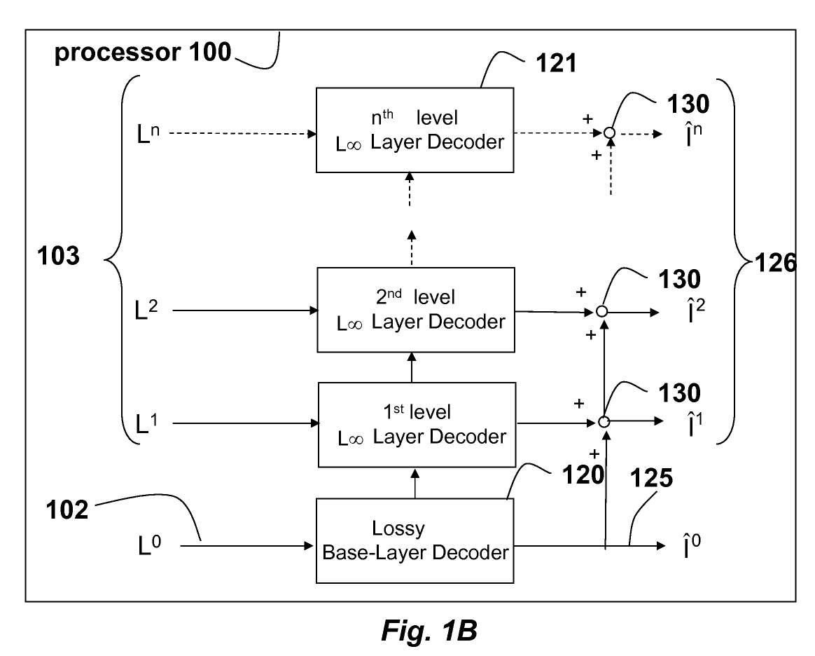

FIGS. 1A and 1B show a multi-layered encoder and decoder, respectively. The steps of the encoder and decoder can be performed in a processor 100 as known in the art.

For encoding, an input depth image (or video) I 101 is encoded as a base layer bitstream L₀ 102, and a set of one or more enhancement layer bitstreams L₂-Lₙ 103. The enhancement layer bitstreams are arranged in a low to high order. The number of enhancement layer bitstreams depends on a bandwidth requirement for transmitting the depth image bit stream. For example, a low bandwidth can only support a small number of enhancement layer bitstreams. As the bandwidth increases, so can the number of enhancement layer bitstreams.

The encoding can be a lossy encoder 110 for the base layer L₀. For images, this could be a conventional encoding scheme, such as JPEG or JPEG 2000, which exploit spatial redundancy. For videos, the lossy encoder can be any conventional video encoding scheme such as MPEG-2 or H.264/AVC, which employs motion-compensated prediction to exploit temporal redundancy.

Then, a difference between the input and the base layer reconstructed image is obtained and provided as input to the first-level L-∞ layer bitstream encoder to produce a first layer bitstream. Then, a difference between the input and the first layer reconstructed image, i.e., the sum of the base layer reconstructed image and the first-layer residual reconstruction, is obtained and provided as input to the second-level L-∞ layer bitstream encoder 111 to produce a second layer bitstream. This process continues for N layers until the N-th layer bitstream is produced.

The multi-layer decoding process inverts the encoding operation. As shown in FIG. 1B, the base layer bitstream decoder 120 reconstructs a base layer image Î₀ 125 from the base layer bitstream 102. The first enhancement layer bitstream L₁ is decoded by the first-layer L-∞ decoder 121 to reconstruct the first layer residual, which is then added 130 to the reconstructed base layer image to yield the first layer reconstructed image Î₁. The second layer bitstream is decoded by the second-layer L-∞ decoder to produce the second layer residual reconstruction, which is then added 130 to the first layer reconstructed image to yield the second layer reconstructed image Î₂. This process continues for each enhancement layer bitstream 126 until the N-th layer reconstructed image is produced.

The number of layers in the set of enhancement layer bitstreams is usually fixed for a given video or application, i.e., not varying over time. However, it can vary with the available bandwidth as described above. A larger number of layer bitstreams provide a greater flexibility in scaling the rate for coding the depth, while ensuring a minimum level of quality for pixels in the depth image. Fewer layers are desirable to minimize overhead that is typical of most scalable coding schemes. Our studies indicate that 2-3 layers are suitable for depth image coding.

This invention describes several embodiments of the method, which vary in the way that enhancement layer bitstream encoding and decoding is performed.

Enhancement Layer bitstream with Inferred Side Information

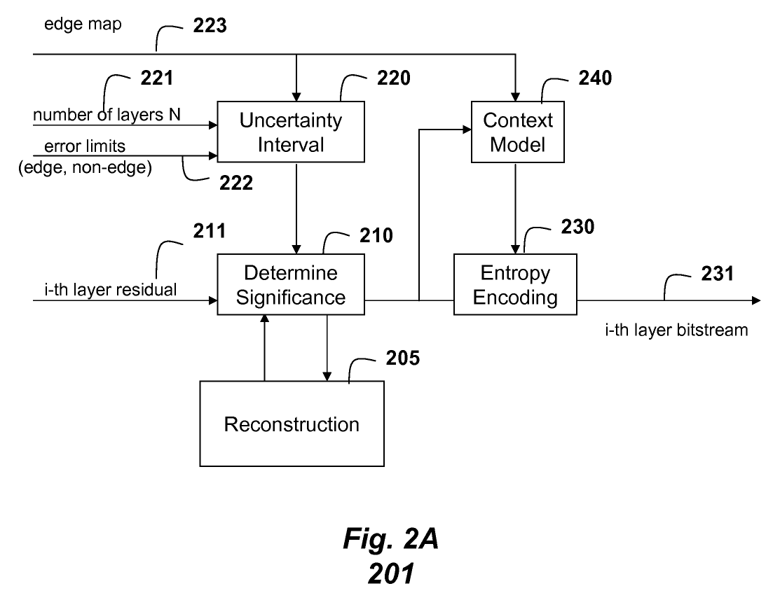

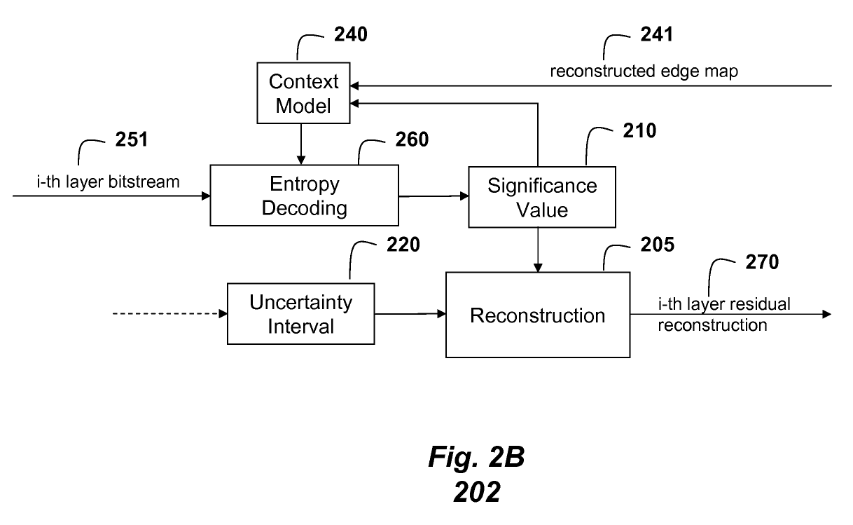

Embodiments of an enhancement layer bitstream encoder 210 and decoder 202 are shown in FIG. 2A and 2B, respectively. The encoder performs the steps of the encoding and decoding methods.

For the reconstruction 205, the encoder determines 210 a significance value for each pixel in the i-th layer residual 211, which is the difference between the input image and the (i−1)-th reconstructed image, based on an uncertainty interval. The uncertainty interval defines an upper and lower bound for the current pixel value in order to limit errors.

A residual value is significant if it falls outside the uncertainty interval. The uncertainty interval 220 indicates a maximum allowable error for the pixel to be decoded, which can vary for the different layers 221, as specified by a layer identifier. The error limits 222 can also vary for different parts of the image. For example, edge pixels can have a lower error limit than non-edge pixels.

An edge map 223 is used to determine the uncertainty interval for each pixel of the image in the current layer. In this particular embodiment of the invention, the edge map is inferred only from reconstructed data available at the decoder in the form of a context model. In this way, no additional side information is needed by the decoder to determine the uncertainty interval. The reconstructed data that can be used includes the (i−1)-th layer reconstructed image and i-th layer residual.

In order to guarantee every pixel in the reconstruction is within the uncertainty interval, a new reconstruction pixel value within the uncertainty interval is assigned to the significant pixel. In “A Wavelet-Based Two-Stage Near-Lossless Coder with L-inf-Error Scalability,” SPIE Conference on Visual Communications and Image Processing, 2006, Yea and Pearlman describe means for assigning the new reconstruction pixel value for a significant pixel. An alternative reconstruction process that is capable of more efficient coding is described below.

The process of assigning a new reconstruction value requires the coding of a sign bit in addition to the significance bit. Depending on the sign bit, a certain value is added or subtracted from the current pixel value. Hence, for a significant pixel, both the significance (value=1) and the sign bits are entropy encoded 230.

For a non-significant pixel, there is no need to assign a new reconstruction value as the value already lies within the uncertainty interval. Therefore, only the significance bit (value=0) needs to be entropy encoded for a non-significant pixel.

In order to efficiently compress the significance and the sign bits, the context model 240 is maintained by entropy encoding to produce an i-th layer bitstream. The use of context model converts the entropy encoding process to a conditional entropy coding process, which reduces the output coding rates by utilizing statistics of the data being coded.

In this embodiment, the maintaining of the context model is based on the statistics of significance bits in a given coding layer. In a preferred embodiment, the statistics of causal neighbors of a current pixel, i.e., data associated with neighboring pixels that have already been encoded or decoded, is considered. The context model also considers whether the current pixel is an edge pixel or non-edge pixel.

As shown in FIG. 2B for the reconstruction 205, the decoder 202 performs the inverse operation. The i-th layer bitstream 251 is entropy decoded 260, based on the context model, to determine 210 the significance value. Based on the uncertainty interval 220 and the significance value, the reconstruction 205 is performed, and the i-th layer residual reconstruction is output 270. The context model 240 is updated and maintained based on significance values obtained at the decoder, and edge map 241. The edge map in this embodiment of the invention is inferred from information available at the decoder.

Enhancement Layer Bitstream with Explicit Side Information

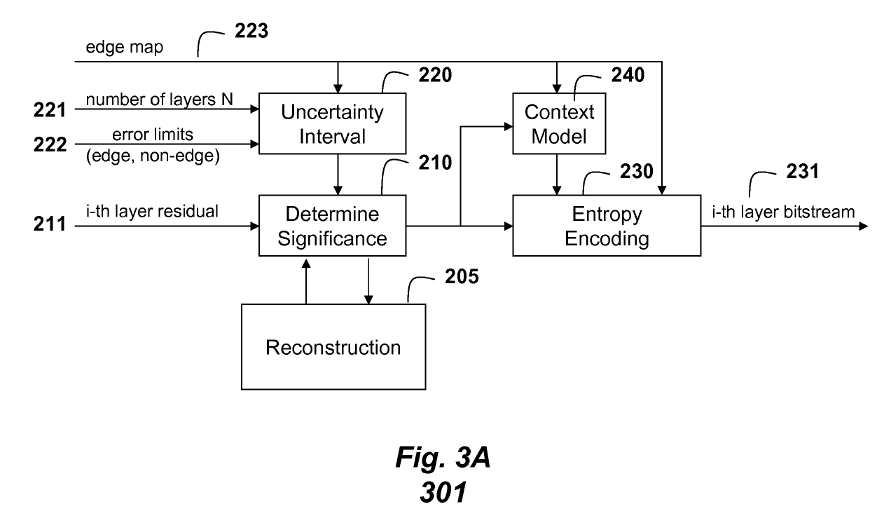

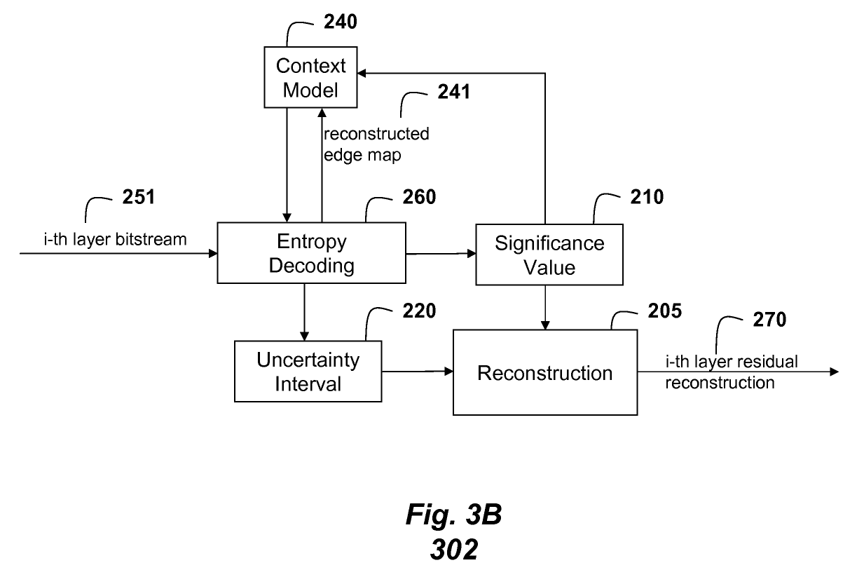

Another embodiment of the enhancement layer bitstream encoder 301 and decoder 302 is shown in FIGS. 3A and 3B, respectively. In this embodiment of the invention, the edge map is obtained from the original input image and coded as side information. An explicit edge map has the benefit of providing more accurate edge information. This requires additional bits to encode.

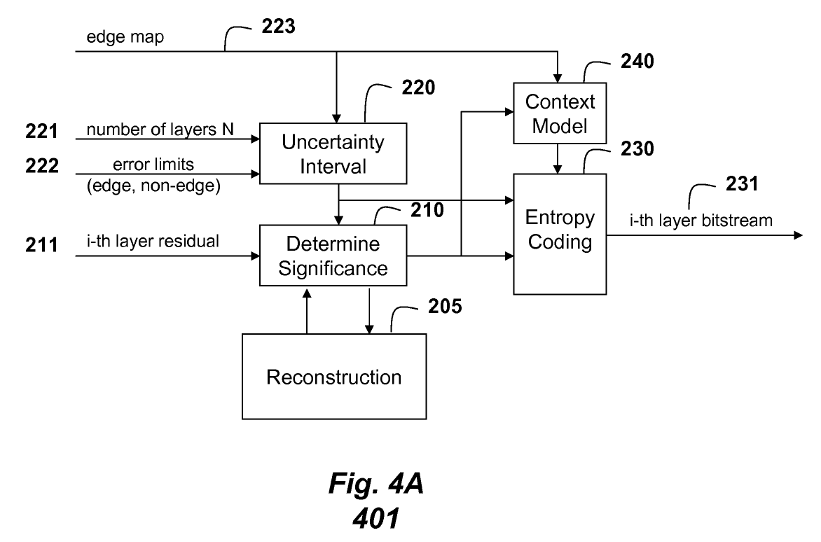

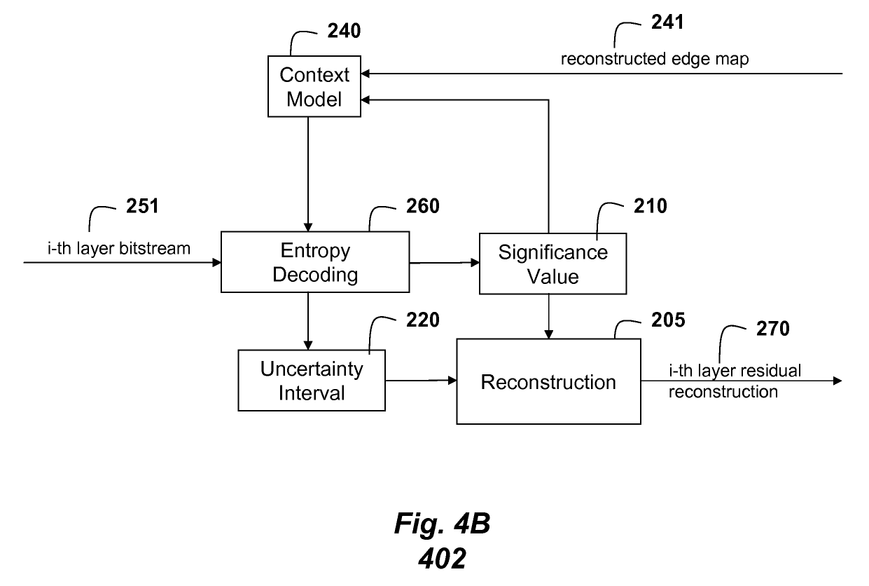

Another embodiment of the enhancement layer bitstream encoder 401 and decoder 402 is shown in FIGS. 4A and 4B, respectively. In this embodiment of the invention, changes in the uncertainty interval are explicitly signaled. Explicit signaling of the uncertainty interval enables adaptive selection of uncertainty intervals according to a criterion, e.g., smaller uncertainty interval for edge pixels.

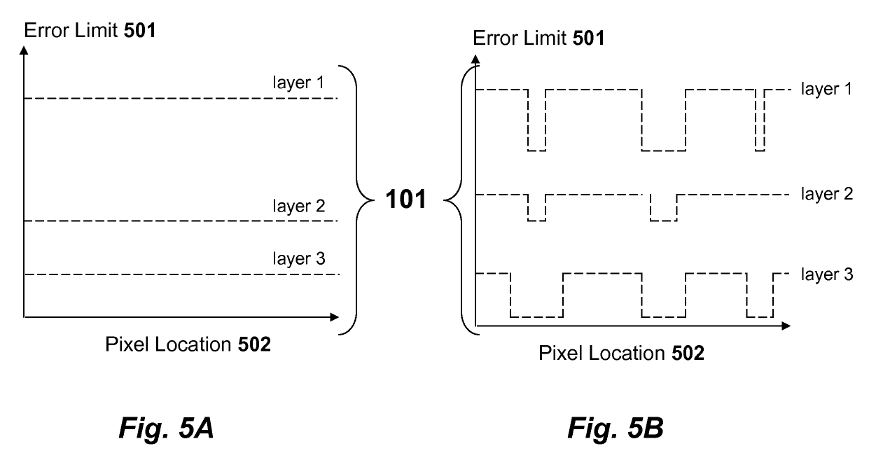

As shown in FIG. 5A, a non-adaptive setting of an error limit 501 for each layer is determined. In this case, the error limit is equal for all pixel positions 502, and independent of local image characteristics.

In FIG. 5B, an adaptive setting of error limit is determined according to pixel position. Lower error limits at each layer are chosen for edge pixels. The difference between error limits for the edge and non-edge pixels can vary in each enhancement layer bitstream. Also, the locations can vary from one layer to another.

Coding Procedure

In the following, methods for determining significance and performing reconstruction are described.

The input image to the i-th layer bitstream encoder is img(i, j) and, and the output reconstructed from the i-th layer bitstream decoder at (i, j) is rec(i, j).

A difference image is

diff(i, j)=img(i, j)−rec(i, j).

The reconstruction rec(i,j) is initially set to zero for every pixel (i, j).

A region of 2^{Lv} by 2^{Lv} pixels in img(,) is QT(i, j, Lv), with the upper-left corner coordinate at (i*2^{Lv}, j*2^{Lv}). We call this a quadtree at (i, j) at level Lv. Assume the input image to the i-th layer bitstream encoder is partitioned into a succession of non-overlapping quadtrees at level Lv following the raster-scan order, i.e., left-to-right and top-to-bottom.

A List of Insignificant Sets (LIS) initially contains every QT(i,j,Lv) as its element. The quadtree is said to be significant against the uncertainty level δ(n) when the following is true:

$${max}_{( x , y ) ∈ QT ( i , j , Lv )} \vert diff ( x , y ) \vert > δ ( n ) ,$$

where (x, y) refers to a pixel in QT(i, j, Lv), and max is a function that returns a maximum value. A maximum uncertainty for the n-th layer bitstream encoder is δ(n).

The n-th layer bitstream encoder is performed in two phases, a first Significance-Phase and a second Refinement-Phase.

Significance-Phase

The Significance-Phase operates as follows:
For each QT(i,j,Lv) in LIS, repeat the steps (1) through (3).
Output the significance test bit (sig) given by

$$sig = \{ \begin{matrix}1 , & if QT ( i , j , Lv ) is significant against δ ( n ) \\ 0 , & otherwise\end{matrix}$$

(If sig=0, goto (1) for next (i, j).
   Otherwise, follow the step (3).
Set level=Lv−1 and run EncodeLIS(i, j,level), where EncodeLIS(i,j,level) is defined as follows:
EncodeLIS(i, j,level)
   If level>0, for each of the four sub-quadtrees
      QT(i, j, level), QT(i+1, j,level),QT(i, j+1,level), and
         QT(i+1, j+1, level), follow steps 2 and 3.
      Otherwise, go to step 4.
   1. Output significance bit (sig) against the uncertainty level δ(n).
   2. If sig=0, return. Otherwise run EncodeLIS(, , level-1).
   3. Put (i,j) into a List of Significant Pixels (LSP(n)) and output:

$$sign = \{ \begin{matrix}0 , & if diff ( i , j ) > 0 \\ 1 , & otherwise .\end{matrix}$$

4. Update the reconstruction rec(i,j):

$$rec ( i , j ) ← \{ \begin{matrix}rec ( i , j ) + δ ( n ) + ⌊ ( δ ( n - 1 ) - δ ( n ) + 1 ) / 2 ⌋ , & if sign = 1 \\ rec ( i , j ) - δ ( n ) - ⌊ ( δ ( n - 1 ) - δ ( n ) + 1 ) / 2 ⌋ , & otherwise\end{matrix}$$

5. Update diff(i,j):

diff(i, j)=img(i, j)−rec(i, j)

Refinement-Phase

The Refinement-Phase refines the pixels in LSP(k)'s (k=1,2, . . . ,n) until the maximum uncertainty becomes less than or equal to the uncertainty level δ(n).

The Refinement-Phase operates as follows:
(1) For each k (k=1,2, . . . ,n), follow the steps below:

Find the maximum uncertainty interval (Gap) of a pixel in LSP(k).

Gap=min{└(δ(k−1)−δ(k))/2┘, δ(n−1)}.
If Gap>δ(n), follow steps (3) through (8).
   Otherwise, go to (1), with k←k+1.
For every pixel (i,j) in LSP(k), output the significance bit (sig) as:

$$sig = \{ \begin{matrix}1 , & if \vert diff ( i , j ) \vert = Gap \\ 0 , & otherwise\end{matrix}$$

If sig=0, go to (8).
   Otherwise, follow steps (4) through (8).
   Output the sign:

$$sign = \{ \begin{matrix}0 , & if diff ( i , j ) > 0 \\ 1 , & otherwise\end{matrix}$$

1. Update the reconstruction rec(i, j):

$$rec ( i , j ) ⇐ \{ \begin{matrix}rec ( i , j ) + Gap , & if sign = 0 \\ rec ( i , j ) - Gap , & otherwise .\end{matrix}$$

2. Update diff(i,j):

diff(i, j)=img(i, j)−rec(i, j)
3. Remove (i, j) from LSP(k)
4. Gap←Gap-1. Go to (2)

Multi-Resolution Depth Coding

The input depth image I 101 in FIG. 1A can be filtered before encoding utilizing filtering techniques, such as the one described in the related Application. Filtering can remove erroneous values in a depth image, and make it easier to compress. The benefit of such an embodiment is that a smaller uncertainty level (δ(n)) can be used for each enhancement layer bitstream without increasing the coding rate while retaining most of the essential information in the input depth image.

The input depth image I 101 in FIG. 1A can also be sub-sampled before encoding and the original resolution of the depth image can be recovered by up-sampling the reconstructed images in FIG. 1B. The down/up-sampling processes as described in the related Application can be used in such an embodiment. The benefit of such an embodiment is that a smaller uncertainty level (δ(n)) can be used for each enhancement layer bitstream without increasing the coding rate while retaining most of the essential information in the original depth image.

### EFFECT OF THE INVENTION

The embodiments of the invention provide a multi-layered coding method for depth images to complement edge-aware techniques, similar to those based on piecewise-linear functions (platelets). The method guarantees a near-lossless bound on the depths near edges by adding extra enhancement layer bitstreams to improve a visual quality of synthesized images. The method can incorporate in any lossy coder for the base layer bitstream and can be extended to videos. This is a notable advantage over platelet-like techniques which are not applicable to videos.

Although the invention has been described by way of examples of preferred embodiments, it is to be understood that various other adaptations and modifications can be made within the spirit and scope of the invention. Therefore, it is the object of the appended claims to cover all such variations and modifications as come within the true spirit and scope of the invention.

We claim:

1. A method for reconstructing a depth image encoded as a depth bitstream including a base layer bitstream, and a set of enhancement layer bitstreams, wherein the set of enhancement layers are arranged in a low to high order, comprising a processor for performing steps of the method, comprising the steps of:
decoding the base layer bitstream to produce pixels of a reconstructed base layer image corresponding to the depth image;
decoding, in the low to high order, each enhancement layer bitstream, wherein the decoding of each enhancement layer bitstream produces a reconstructed residual image, further comprising,
maintaining a context model using an edge map corresponding to the depth image;
entropy decoding each enhancement layer bitstream using the context model to determine a significance value corresponding to pixels of the reconstructed residual image and a sign bit for each significant pixel; and
reconstructing a pixel value of the reconstructed residual image according to the significance value, sign bit and an uncertainty interval; and
adding the reconstructed residual images to the reconstructed base layer image to produce a reconstructed depth image, wherein the reconstructed depth image has a maximum error relative to the depth image corresponding to the uncertainty interval associated with the highest enhancement layer.

2. The method of claim 1, wherein the pixel value is associated with an error limit.

3. The method of claim 2, wherein the error limit varies for each enhancement layer bitstream.

4. The method of claim 2, wherein the error limit varies according to local image characteristics.

5. The method of claim 4, wherein the local image characteristics include edges.

6. The method of claim 1, wherein the depth image is used for virtual view synthesis.

7. The method of claim 1, wherein a number of the enhancement layer bitstreams depends on a bandwidth for transmitting the depth bitstream.

8. The method of claim 1, wherein the context model is additionally maintained based on statistics of the significance values and the sign bits.

9. The method of claim 1, wherein the edge map is inferred during the decoding.

10. The method of claim 1, wherein the edge map is included in the depth bitstream by the encoding.

11. The method of claim 1, wherein the uncertainty interval is explicitly signaled in the depth bitstream.

12. The method of claim 11, further comprising:
entropy decoding the uncertainty interval for each enhancement layer bitstream.

13. The method of claim 1, further comprising:
encoding, in a lossy manner, the depth image to produce the base layer bitstream;
determining, for each enhancement layer bitstream, a residual image as a difference between the depth image and the reconstructed depth image of a prior layer, where the prior layer is the base layer bitstream for the first enhancement layer bitstream, and otherwise a prior enhancement layer bitstream; and
encoding, for each enhancement layer bit stream, the residual image to produce the set of enhancement layer bitstreams.

14. The method of claim 13, wherein the encoding further comprises:
determining the significance value for pixels in the residual image;
assigning the uncertainty interval based on the edge map corresponding to the depth image;
determining, for significant pixels, a sign bit based on whether the pixel value in the residual image is positive or negative;
performing a reconstruction based on the significance value, the sign bit and the uncertainty interval; and
entropy encoding the significance value and the sign bit.

15. The method of claim 14, where the uncertainty interval varies for each enhancement layer bitstream.

16. The method of claim 14, further comprising:
adapting the uncertainty interval according to local image characteristics.

17. The method of claim 16, further comprising:
entropy encoding the uncertainty interval for each enhancement layer bitstream.

18. The method of claim 10, wherein the edge map is inferred from the reconstructed depth image.

19. The method of claim 14, wherein the edge map is determined according to the depth image.

20. The method of claim 19, further comprising:
encoding the edge map as part of the depth bitstream.

21. The method of claim 13, further comprising:
down-sampling the depth image.

22. The method of claim 1, further comprising:
up-sampling the reconstructed depth image.

23. The method of claim 1, wherein a sequence of depth images are included in the base layer bitstream and the encoding is lossy, and utilizes prediction to exploit temporal redundancy.

24. The method of claim 14, wherein a particular pixel of the residual image is significant when an absolute value of the particular pixel is greater than the uncertainty interval.

25. The method of claim 14, wherein a set of pixels of the residual image is significant when a maximum of absolute values among the set of pixels is greater than the uncertainty interval, and the set of pixels is insignificant when a maximum of the absolute values among the set of pixels is less than or equal to the uncertainty interval.

26. The method of claim 25, further comprising:
partitioning, recursively, the set of pixels into a plurality of subsets of pixels until each subset of pixels either includes one pixel or the subset of pixels is insignificant.

27. The method of claim 26, wherein the partitioning is a quadtree decomposition.

28. A decoder for reconstructing a depth image encoded as a depth bitstream including a base layer bitstream, and a set of enhancement layer bitstreams, wherein the set of enhancement layers are arranged in a low to high order, comprising:
a lossy base layer decoder configured to produce pixels of a reconstructed base layer image corresponding to the depth image;
a set of enhancement layer decoders, wherein there is one enhancement layer decoder for each enhancement layer bitstream, and wherein the set of enhancement layers are decoded in the low to high order, and wherein the decoding of each enhancement layer bitstream produces a reconstructed residual image; and wherein each enhancement layer decoder further comprises:
means for maintaining a context model using an edge map corresponding to the depth image;
means for entropy decoding each enhancement layer bitstream using the context model to determine a significance value corresponding to pixels of the reconstructed residual image and a sign bit for each significant pixel; and
means for reconstructing a pixel value of the reconstructed residual image according to the significance value, sign bit and an uncertainty interval; and
means for adding the reconstructed residual images to the reconstructed base layer image to produce a reconstructed depth image, wherein the reconstructed depth image has a maximum error relative to the depth image corresponding to the uncertainty interval associated with the highest enhancement layer.
